(19) United States
(12) Patent Application Publication
(10) Pub. No.: US 2008/0262998 A1
(43) Pub. Date: Oct. 23, 2008

(54) Systems and methods for personalizing a newspaper

(76) Inventors: Alessio Signorini, Metuchen, NJ (US); Giuseppe Ottaviano, Raguza (IT); Antonio Gulli, Pisa (IT)

Correspondence Address: Jennifer Hayes;BLAKELY, SOKOLOFF, TAYLOR & ZAFMAN LLP, Seventh Floor, 12400 Wilshire Boulevard, Los Angeles, CA, 90025, US

(21) Appl. No.: 11/787,780

(22) Filed: Apr. 17, 2007

(51) Int. Cl. G06F 17/30

(52) U.S. Cl. 707/2

(57) ABSTRACT

Systems and methods for presenting news information and personalizing presentation of news information are disclosed. Users are presented with a selectable, visual representation of the news information. Users can access additional news information and/or a personalized newspaper by selecting a visual representation of the news information. Systems and methods for monitoring user selection and modifying the personalized newspaper are also disclosed.

### FIELD

This invention relates to the field of presentation of information on the Internet and, in particular, to systems and methods for personalizing a newspaper.

### BACKGROUND

The Internet is a global network of computer systems and websites. These computer systems include a variety of documents, files, databases, and the like, which include information covering a variety of topics. Internet users are more frequently using the Internet as a source for news information, displacing conventional newspapers as their source for news information.

Some websites offer web page personalization to these users. Users are typically prompted to select from a list of available news categories and/or news providers. These broad sets of information are then provided to the users on their personalized web page. The user is not able to narrow the set of information provided within the category. In addition, these personalized webpages only provide users with a title of a news article in that broad category, typically without any additional information, such as an abstract or image or other relevant information. The user must select the title to get any additional information, such as the abstract, image or the full article.

The user also has a limited ability to modify the layout of the web page. In addition, these personalized web pages cannot be shared with other Internet users.

### SUMMARY

Systems and methods for presenting electronic information are disclosed herein.

In one embodiment, the method includes clustering news information according to a topic to create topic clusters, each topic cluster having a news information object associated with the topic cluster; presenting the news information objects associated with the topic clusters in a user interface; and receiving a user selection of one or more of the news information objects in the user interface.

The method may also include presenting the user with news information associated with the selected topic clusters.

The method may also include allowing the user to access a personalized newspaper, the personalized newspaper including news information associated with the topic cluster.

The method may also include associating a news information object with a topic cluster.

The topic cluster may be part of a topic chain, and the news information object may be associated with the topic chain.

The news information object may include a representative image and a representative title.

The user selection may be a mouse click.

The method may also include highlighting the news information object in the user interface when a user selection is received.

The method may also include presenting the user with an article from a selected topic cluster.

The personalized newspaper may include an article from a selected topic cluster.

The method may also include storing user selection of news information objects.

The method may also include presenting the user with unselected news information based on stored user selections.

The method may also include presenting the user with updated news information based on stored user selections.

In one embodiment, the method includes allowing a user to access a collection of visual objects, each visual object associated with at least one news article; receiving a user selection of one or more visual object from the collection of visual objects; and presenting a personalized newspaper including news information relating to the at least one news article associated with each selected visual object. In one embodiment, the visual object may be an image, video, podcast, and the like, and combinations thereof.

Each visual object in the collection of visual object may be associated with a representative title, the user selecting either or both of the one or more visual objects or representative titles.

The method may also include presenting an abstract of a selected news article and a link to access the entire article.

The method may also include receiving a user modification of a layout of the personalized newspaper.

The method may also include allowing a user to share the personalized newspaper.

The collection of visual objects may be categorized, and the user may be allowed to access the visual objects based on a selected category.

The method may also include providing the user with unselected news information related to a selected article.

### BRIEF DESCRIPTION OF THE DRAWINGS

The invention is described by way of example with reference to the accompanying drawings, wherein:

FIG. 1 is a block diagram illustrating a system in accordance with one embodiment of the invention;

FIG. 2 is a block diagram illustrating a method of clustering news information in accordance with one embodiment of the invention;

FIG. 2A is a block diagram illustrating organization of news information in accordance with one embodiment of the invention;

FIG. 2B is a block diagram illustrating organization of news information in accordance with one embodiment of the invention;

FIG. 3 is a schematic view of a user interface for presenting news information in accordance with one embodiment of the invention;

FIG. 4 is a screen shot of an exemplary user interface for presenting visual information for user selection of news information in accordance with one embodiment of the invention;

FIG. 5 is a screen shot of an exemplary user interface illustrating user selection of news information in accordance with one embodiment of the invention;

FIGS. 6A-6D are screen shots of an exemplary user interface illustrating categorization of news information in accordance with one embodiment of the invention;

FIGS. 7A-7B are screen shots of an exemplary user interface illustrating presentation of user selected information in accordance with one embodiment of the invention;

FIG. 8 is a screen shot of an exemplary user interface illustrating an alternative presentation of user selected information in accordance with one embodiment of the invention;

FIG. 9 is a screen shot of an exemplary user interface illustrating a login system of the exemplary user interface in accordance with one embodiment of the invention;

FIG. 10 is a screen shot of an exemplary user interface illustrating a login system of the exemplary user interface in accordance with one embodiment of the invention;

FIG. 11 is a screen shot of an exemplary user interface illustrating a presentation of user selected information in accordance with one embodiment of the invention;

FIG. 12 is a screen shot of an exemplary user interface illustrating a technique for sharing a personalized newspaper in accordance with one embodiment of the invention; and

FIG. 13 is a screen shot of an exemplary user interface illustrating a technique for sharing a personalized newspaper in accordance with one embodiment of the invention.

### DETAILED DESCRIPTION

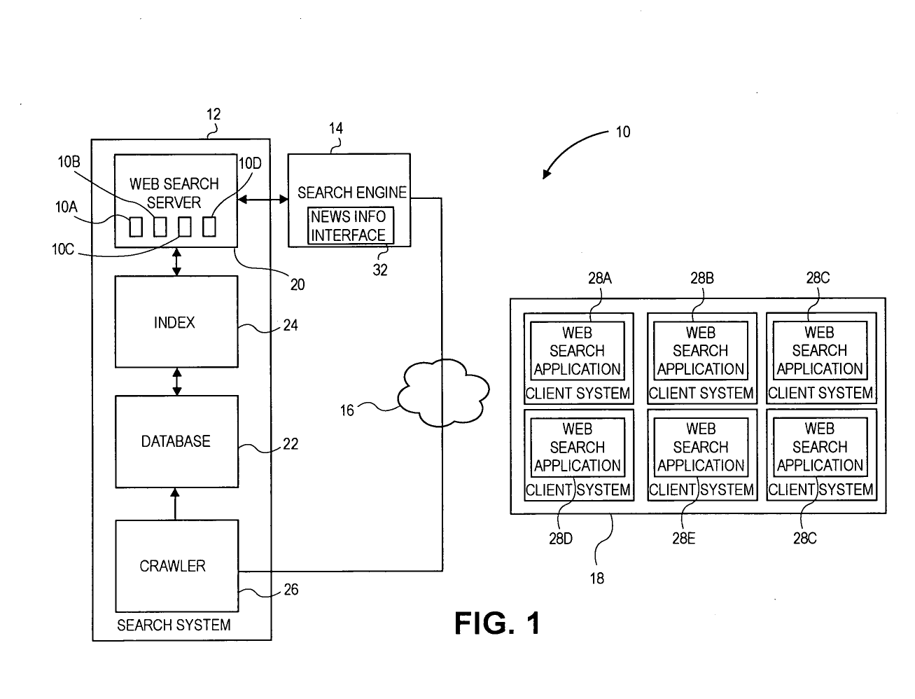

FIG. 1, of the accompanying drawings, shows a network system 10 which can be used in accordance with one embodiment of the present invention. The network system 10 includes a search system 12, a search engine 14, a network 16, and a plurality of client systems 18. The search system 12 includes a server 20, a database 22, an indexer 24, and a crawler 26. The plurality of client systems 18 includes a plurality of web applications 28a-f, located on each of the plurality of client systems 18. The server 20 may include a plurality of databases 30a-d. The search engine 14 may also include a news information interface 32.

The server 12 is connected to the search engine 14. The search engine 14 is connected to the plurality of client systems 18 via the network 16. The server 20 is in communication with the database 22 which is in communication with the indexer 24. The indexer 24 is in communication with the crawler 26. The crawler 26 is capable of communicating with the plurality of client systems 18 via the network 16 as well.

The web search server 20 is typically a computer system, and may be an HTTP server. It is envisioned that the search engine 14 may be located at the web search server 20. The web search server 20 typically includes at least processing logic and memory.

The indexer 24 is typically a software program which is used to create an index, which is then stored in storage media. The index is typically a table of alphanumeric terms with a corresponding list of the related documents or the location of the related documents (e.g., a pointer). An exemplary pointer is a Uniform Resource Locator (URL). The indexer 24 may build a hash table, in which a numerical value is attached to each of the terms. The database 22 is stored in a storage media, which typically includes the documents which are indexed by the indexer 24. The index may be included in the same storage media as the database 22 or in a different storage media. The storage media may be volatile or non-volatile memory that includes, for example, read only memory (ROM), random access memory (RAM), magnetic disk storage media, optical storage media, flash memory devices and zip drives.

The crawler 26 is a software program or software robot, which is typically used to build lists of the information found on web sites. Another common term for the crawler 26 is a spider. The crawler 26 typically searches web sites on the Internet and keeps track of the information located in its search and the location of the information.

The network 16 is a local area network (LAN), wide area network (WAN), a telephone network, such as the Public Switched Telephone Network (PSTN), an intranet, the Internet, or combinations thereof.

The plurality of client systems 18 may be mainframes, minicomputers, personal computers, laptops, personal digital assistants (PDA), cell phones, and the like. The plurality of client systems 18 are capable of being connected to the network 16. Web sites may also be located on the client systems 18. The web application 28a-f is typically an Internet browser or other software. It will be appreciated that the number of client systems 18 is not limited to the number shown.

The databases 30a-d are stored in storage media located at the server 20. The storage media may be volatile or non-volatile memory that includes, for example, read only memory (ROM), random access memory (RAM), magnetic disk storage media, optical storage media, flash memory devices and zip drives. It will be appreciated that a smaller number or greater number of databases may be provided than those illustrated.

In use, the crawler 26 crawls websites, such as the websites of the plurality of client systems 18, to locate information on the web. The crawler 26 employs software robots to build lists of the information. The crawler 26 may include one or more crawlers to search the web. The crawler 26 typically extracts the information and stores it in the database 22. The indexer 24 creates an index of the information stored in the database 22. Alternatively, if a database 22 is not used, the indexer 24 creates an index of the located information and the location of the information on the Internet (typically a URL).

When a user of one of the plurality of client systems 18 enters a search on the web application 28, the search is communicated to the search engine 14 over the network 16. The search engine 14 communicates the search to the server 20 at the search system 12. The server 20 accesses the index and/or database to provide a search result, which is communicated to the user via the search engine 14 and network 16.

If a user of one of the plurality of client systems 18 accesses the news information interface 32 through the web search application 28, the search engine 14 still communicates the search to the server 20, which provides a search result. The search result may be obtained from either or both the web index and a dedicated news information index. The search result is typically searchable news information. As will be described hereinafter, the news information is searchable using a search query, such as a keyword or natural language search, or using a browser.

In one embodiment, the search engine may be a news engine. A news engine is a search engine specialized in searching and browsing news articles, blog postings and related user comments. As discussed above, the articles and other related news information may be located by crawling of web pages or documents available on the Internet. In addition, pull technologies, such as RSS, Atom feeds, XML and the like may be used to locate the news information. News information can also be obtained through direct submission by users or companies. News information may include news articles, blogs, RSS/Atom feeds, video news, photographs, audio content, a stream of textual information enriched with other media content, or any other media content. Each article may have one or more multimedia elements associated therewith. Exemplary multimedia elements include images, videos, audio content and the like. Each article may also be classified under a category. Exemplary categories include World, National Stories, Politics, Business, Sports, Entertainment, Science, Health, Technology, and the like. In one embodiment, the news information is classified by the search engine, after it is received, into the category by a classifier (not shown).

In embodiments wherein the search engine is a news search engine, the crawler 26 may search the web for news information and store the news information and/or properties of the news information in index and/or database, and/or in a dedicated news index and/or news database (not shown). It will be appreciated that different crawlers may be provided for different types of news information. In one embodiment, a separate crawler is provided for each of news articles, blogs, etc.

Searchable news information, as will be described hereinafter, may be stored in one or more of databases 30a-d. The news information interface 32 may be connected to the server, one or more databases 30a-d having news information stored therein, database 22 and/or indexer 24. In one embodiment, each database 30a-d includes news information to a particular category or classification. In another embodiment, each database 30a-d includes different types of news information (e.g., news articles, blogs, images, etc.).

In one embodiment, the news search system is one aspect of a multi-purpose search system. In another embodiment, the news search system may be an independent search system. In one embodiment, the news search system includes a dedicated news crawler, news indexer, news database, news server, and the like, with the news interface being directly connected to the news search system.

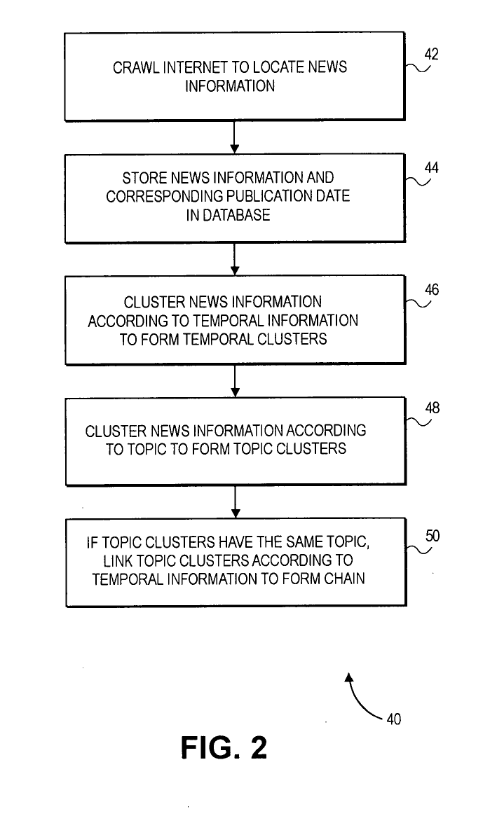

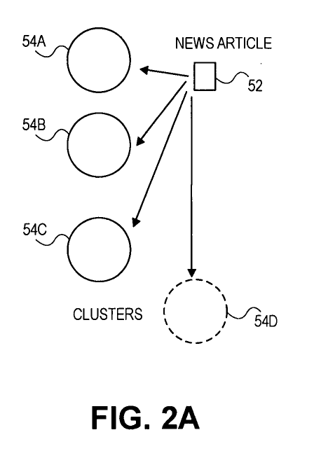

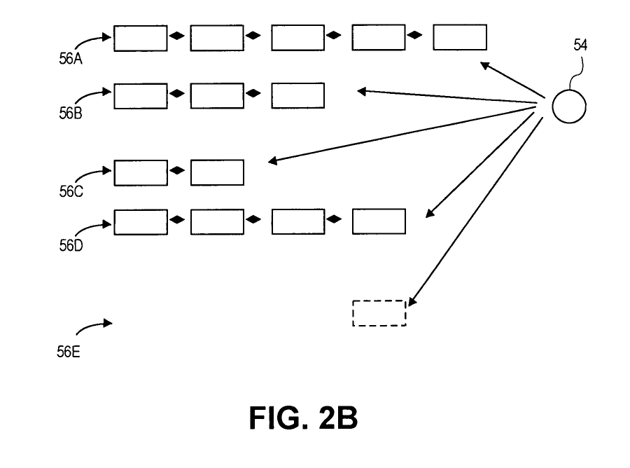

FIG. 2 illustrates a method 40 for clustering a stream of information in accordance with one embodiment of the invention. Clustering the stream of information allows news information related to the same story or topic to be grouped together. It will be appreciated that other methods for clustering a stream of information may be used and the process may vary from that illustrated.

The method 40 begins at block 42, where a crawler, such as crawler 16 (FIG. 1) or a dedicated news information crawler, searches the Internet to locate news information. At block 44, located news information (and/or properties about the news information) is stored in an index and/or database. At block 46, the news information is clustered according to temporal information to form temporal clusters. At block 48, the temporal clusters are clustered according to topic to form topic clusters. At block 50, if topic clusters have the same topic, the topic clusters are linked together to form a chain according to the temporal information.

FIG. 2A illustrates an exemplary process for identifying a topic cluster for a news article. For each news article 52, the system determines whether an existing cluster 54a-c is related to the same topic as the news article 52. If the news article 52 is related to the same topic as one of the existing clusters 54a-c, the news article 52 is added to the corresponding existing cluster. If the news article 52 is not related to the same topic as one of the existing clusters 54a-c, a new cluster 54d is formed for the topic corresponding to the news article 52.

FIG. 2B illustrates an exemplary process for identifying a topic chain for a cluster. For each cluster 54, the system determines whether an existing chain 56a-d is related to the same topic as the cluster 54. If the cluster 54 is related to the same topic as one of the existing chains 56a-d, the cluster 54 is added to the corresponding existing chain. If the chain 54 is not related to the same topic as one of the existing clusters 56a-d, a new chain 56e is formed for the topic corresponding to cluster 54.

In one embodiment, temporal clustering is carried out on daily basis. In this case, the chains of previous days may be consolidated and stored off-line for efficiency reasons. The clusters formed for the current day may be created every m minutes, for example, and dynamically merged with the offline chains.

Each of the clusters and/or chains is typically stored in the external memory. Typically, the external memory includes a database, such as one or more of databases 30a-d, and/or an index, as described hereinabove.

The temporal information used to cluster the information is typically the publication date and/or time, posting date and/or time, clustering date and/or time (i.e., when the news information is clustered) or crawling date and/or time (i.e., when the news information is located, indexed and/or stored by the crawler).

The process for clustering a stream of information typically occurs periodically. The process of classifying a stream of information may also occur periodically. The crawler 26 typically locates more news information each time it searches the Internet; thus, the above process may occur concurrently with crawling. Alternatively, a window of time co, such as an hour, a day, a week, etc. is selected for clustering. It will also be appreciated that news stories in different categories may be clustered at different periods of time and, thus, different periods of time can be selected for different news categories. For example, business news is typically updated more frequently than world news; thus, the time increment for clustering business news may be more frequent (e.g., every five minutes) than the time increment for clustering world news (e.g., every hour).

A clustering algorithm is used to cluster the information. An exemplary clustering algorithm is disclosed in U.S. patent application Ser. No. 11/417,405, filed May 3, 2006, the entirety of which is hereby incorporated by reference. In one embodiment, the news information is clustered according to a selected window of time ω. New clusters can be periodically linked to chains or new topic clusters can be identified periodically. The new clusters are compared to other clusters to discover similarities in topic. When similarities are found among clusters in different time windows, the clusters are linked together to form a chain or are added to a preexisting chain. This comparison with clusters in previous time windows can stop if no similar information is found for a period of time proportional to the extension of the current cluster or to an extension of the chain. The chain of clusters is organized in a hierarchy according to the temporal information of each cluster: the most recent cluster is typically displayed at the top of the chain and the oldest cluster is typically displayed at the bottom of the chain.

Clusters may be represented by visual and nonvisual information or objects. In one embodiment, the clusters are represented by a multimedia element or visual or nonvisual information/object associated with the news information. For example, the visual information may include an image or video associated with the cluster. The nonvisual information may be a title for the cluster. The title of the cluster may be the complete title of an article in the cluster, a substring of the title of a cluster's article, a novel title automatically generated using the titles of the articles in the cluster, or the like. In one embodiment, the clustering algorithm includes associating the visual and/or nonvisual information with the cluster. It will be appreciated that a chain may be similarly represented by visual and nonvisual information.

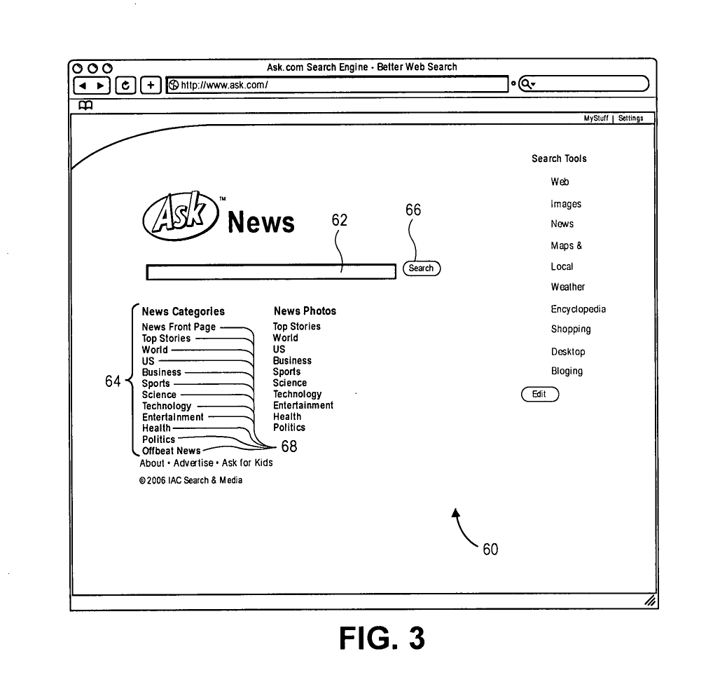

FIG. 3 shows an exemplary user interface 60 for selecting news information in accordance with one embodiment of the present invention. The user interface 60 may be connected to or otherwise related to the news information interface 32 (FIG. 1).

The illustrated user interface 60 includes a search box 62 and a list of selectable news categories 64.

The search box 62 may also include a selectable button 66. Users of the user interface 60 enter a search query into the search box 62 and select the selectable button 66 to search for news information related to the search query. The search query may be, for example, a keyword search or a natural language search.

The list of selectable news categories 64 may include selectable links 68 corresponding to each of the categories in the list of selectable news categories 64. Users of the user interface 60 select one of the selectable links 68 from the list of selectable news categories 64 to link to browsable news information relating to the selected news category. It will be appreciated that any number or type of news categories may be presented to a user for selection. For example, the illustrated news categories 64 include top stories, world, U.S., business, sports, science, technology, health, politics, entertainment and offbeat news.

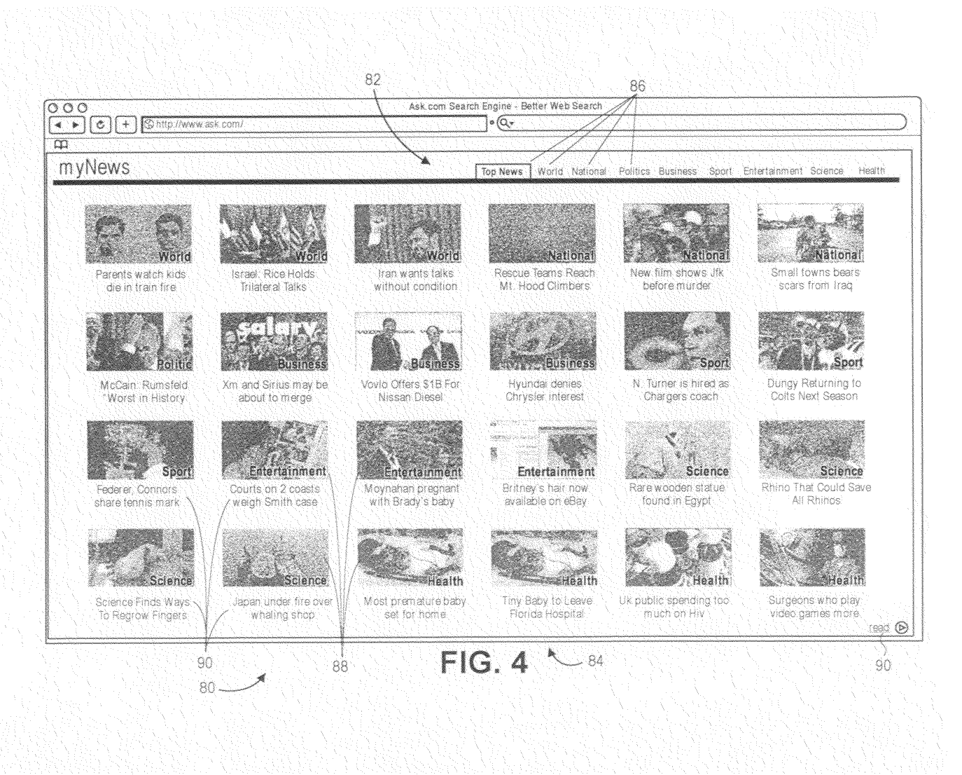

FIG. 4 is a user interface 80 for presenting news information in accordance with one embodiment of the invention. In one embodiment, the user interface of FIG. 4 may be used for personalization of news searching (e.g., query or browsing). In one embodiment, the user interface 80 is accessible from the interface 60 of FIG. 3. For example, if a user selects a category link 68, the category link 68 redirects the user to user interface 80. In another example, a “my news” link (not shown) may be provided on user interface 60, the “my news” link redirecting the user to interface 80. In another embodiment, a user automatically arrives at user interface 80 when they access the website associated with the news search system.

In FIG. 4, the user interface 80 includes a header 82 and a main portion 84. The header 82 includes a plurality of tabs 86. Each of the illustrated tabs corresponds to a news category. For example, in FIG. 4, the tab corresponding to “Top News” is highlighted.

A plurality of images 88 are shown in the main portion 84. The images 88 also have text 90 associated therewith. Each of these images 88 and corresponding text 90 is associated with a news article, news cluster or news article. The images 88, text 90, and associated news article, cluster or chain are from the selected category, corresponding to the selected tab 86.

The main portion 84 also includes a link 92, designated by “read” with an arrow next to it in FIG. 4. As will be explained in detail hereinafter, the link 92 directs the user to a personalized newspaper in accordance with one embodiment of the invention.

The interface 80 provides a visual interface. The visual interface includes a collection of images (or videos) associated with the articles, cluster, and/or chain. The visual information may also include some text therewith, such as a title of the article, cluster, and/or chain, or certain keywords associated with the visual information.

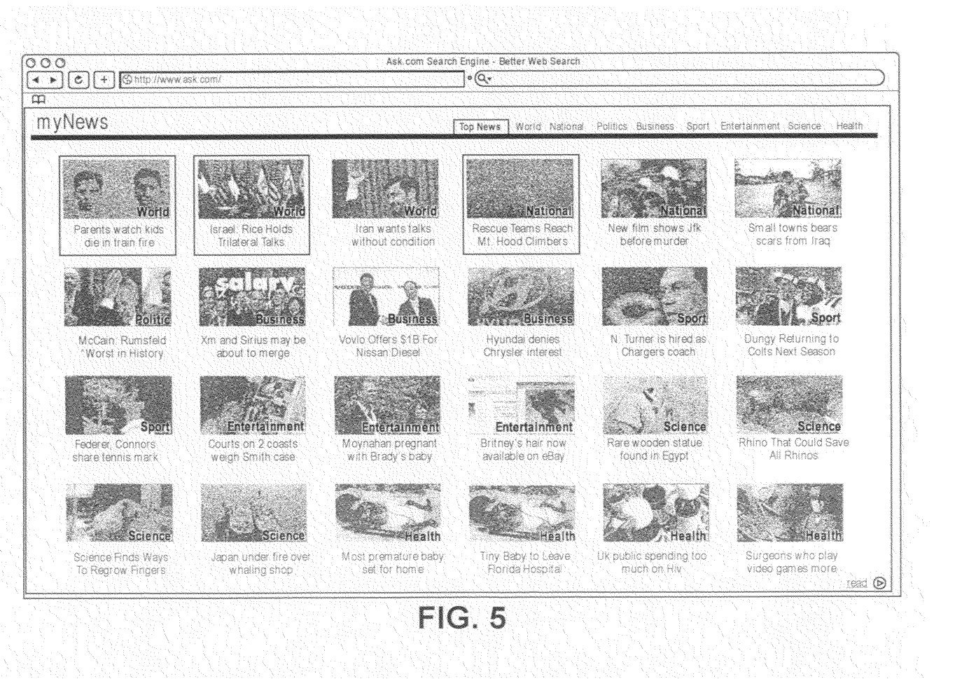

In use, a user reviews the images 88 and text 90 in the interface 80. The user can select the images 88 and text 90 if the user wants to access more information about the corresponding story (e.g., article, cluster or chain). FIG. 5 shows boxes 94 around three of the images 88 and text 90, corresponding to a user selection of an article. It will be appreciated that user selection may be designated in other ways than that illustrated in FIG. 5.

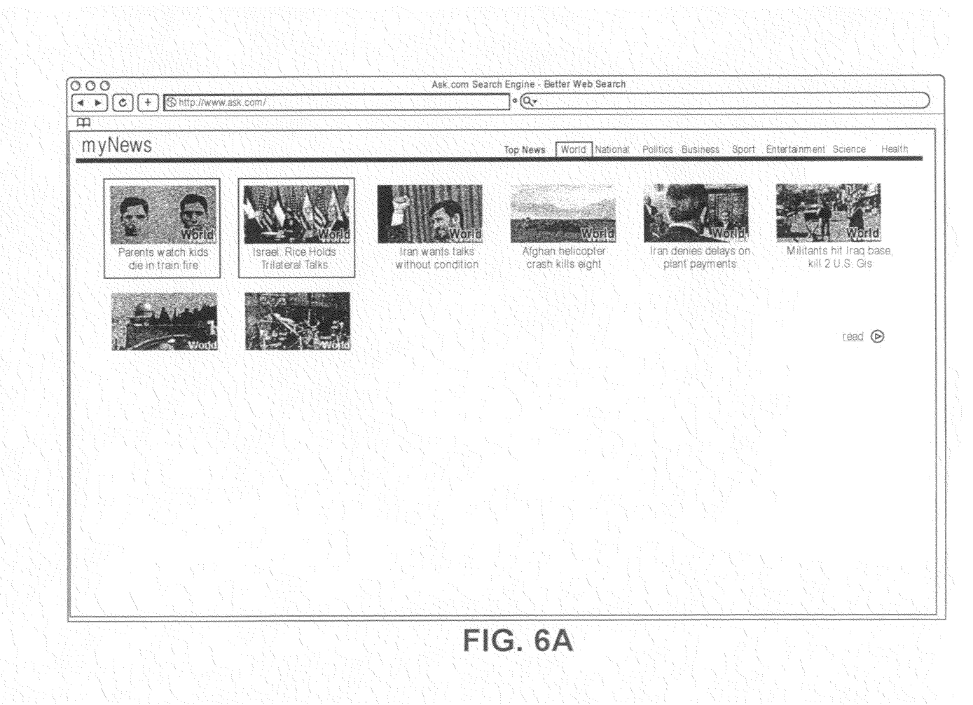

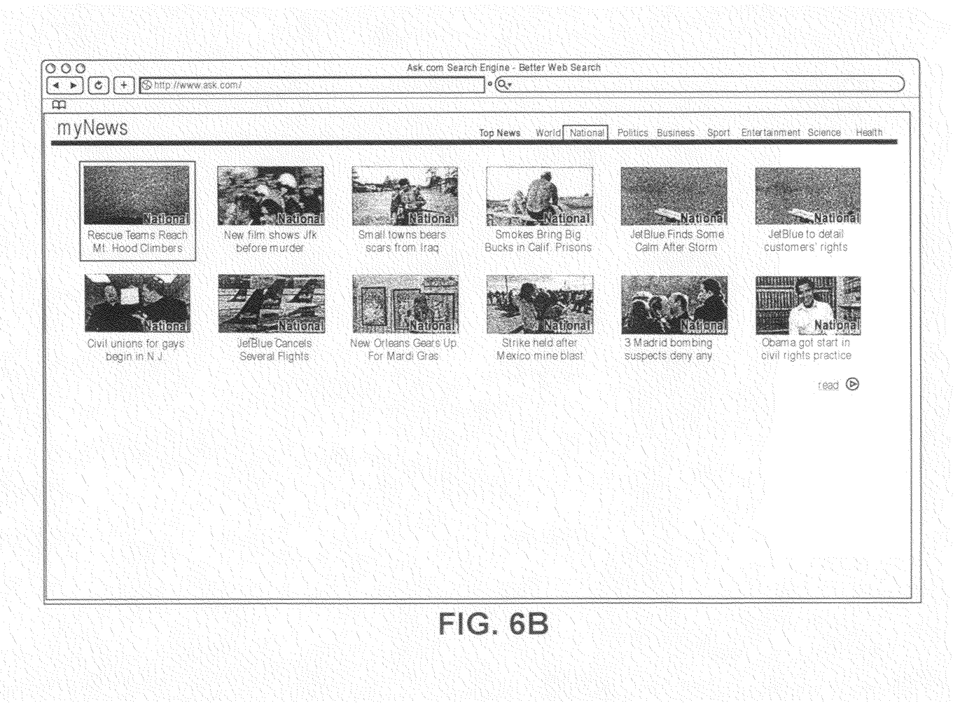

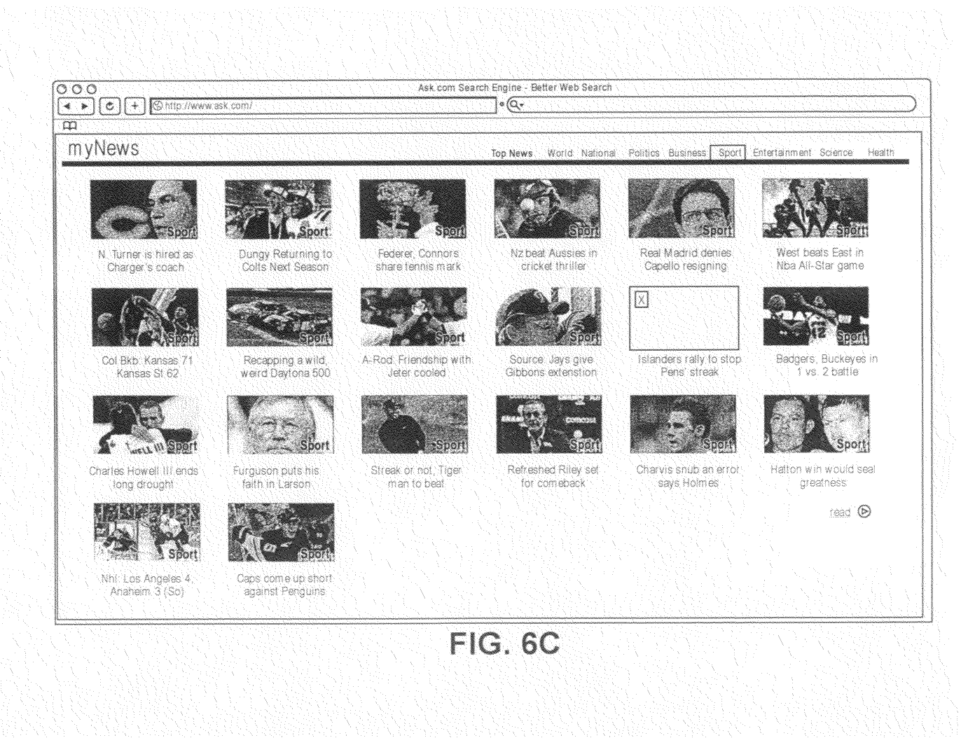

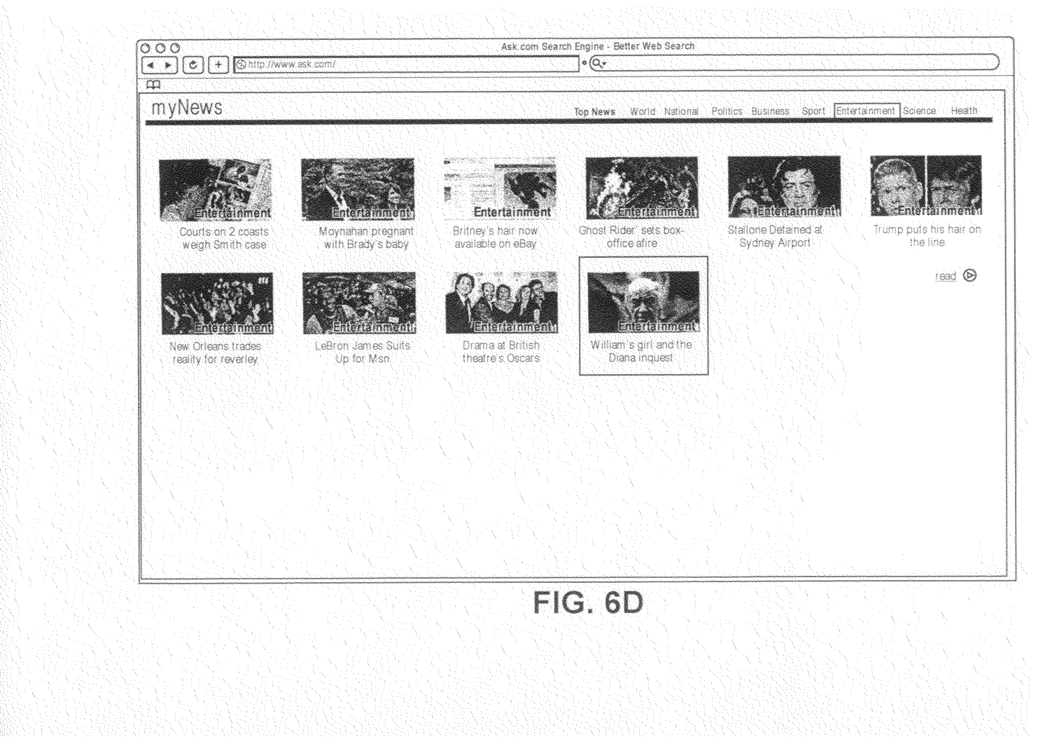

The user can also select articles from various categories, as illustrated in FIGS. 6A-6D. In FIGS. 6A-6D, only images 88 and text 90 from each category are illustrated in the main portion 84 of the user interface 80. Thus, if a user prefers news information in certain categories, the user can navigate directly to those categories by selecting the corresponding tabs 86 in the header portion 82 of the user interface 80. For example, if the user is only interested in news in the “Business” and “Entertainment” categories, the user can select the tabs corresponding to the “Business” and “Entertainment” categories, to view the images in each respective category.

Thus, each user can select their news of interest from the categorized news pages, a personalized summary of other categories, or from each specific category. In essence, the users manage a virtual basket where they can add or remove the information they are interested in for collection or later review. By visually selecting the news information, each user can personalize the set of news information in which they are interested.

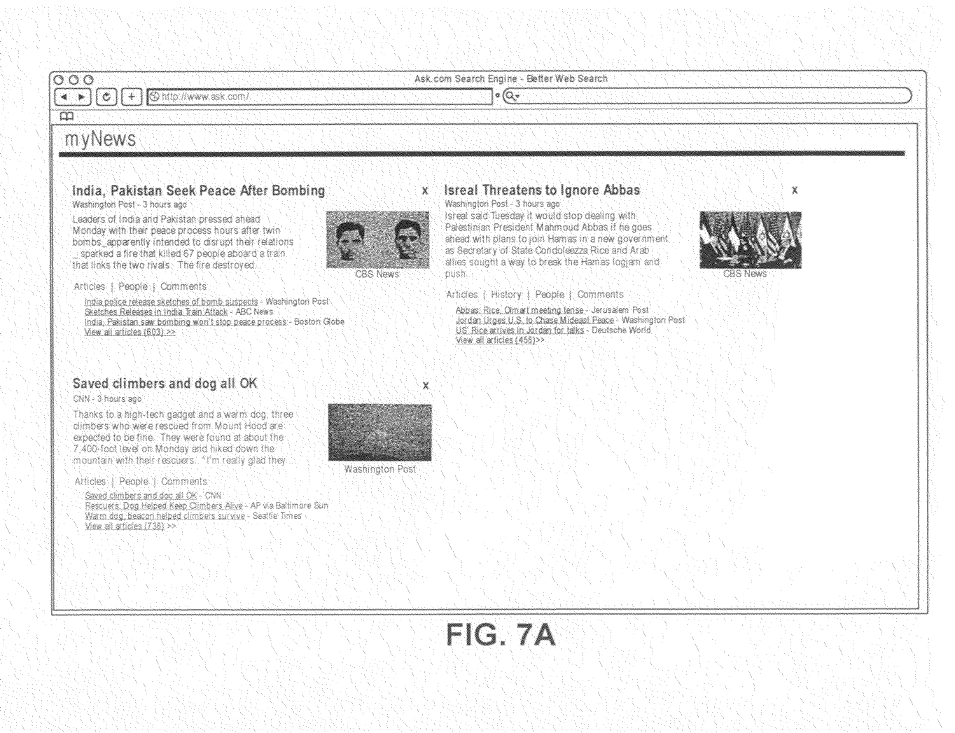

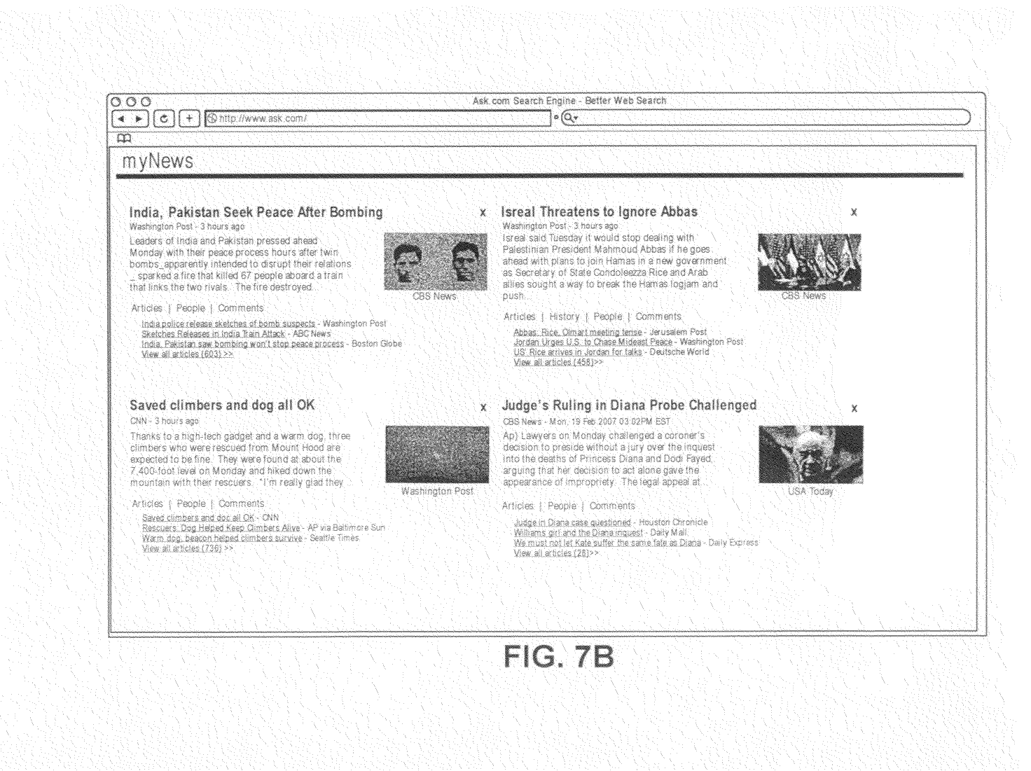

After the user has selected news articles by selecting the images 88 in the interface 80, the user can select the link 92 to access a personalized newspaper. FIGS. 7A and 7B show exemplary personalized newspapers.

The personalized newspaper includes articles selected by the user, as indicated above (see FIG. 7A). As discussed above, articles may also be clustered into clusters and/or chains. A cluster of articles or a chain of articles are articles written about a common topic, and a chain is an ordered set of clusters of articles with the same topic as the article/cluster with which the chain is associated. In FIG. 7A, the personalized newspaper includes the collection of selected stories shown together with the associated news articles, past correlated clusters, blog postings, user comments, images, videos and sounds (i.e., news information associated with, for example, a cluster).

Each story may be represented by multiple objects. These objects may include a representative title, a snippet of the main article, an authoritative multimedia object (e.g., image, video, audio content) associated with the cluster, a cluster of related news article(s), an authoritative title of past clusters of related news articles, a cluster of related blogs and/or blog postings, authoritative entities (e.g., people, companies, places, events, etc.) involved in the story, comments posted by users on the topic, and the like.

Each of the articles can be selected to get more news information. For example, if a user selects a title from a selected cluster, the user may then access the entire article. In another example, if a user selects a link associated with a person (i.e., authoritative entity) related to the cluster, the user may then access a description of the person.

In addition, the system can provide or suggest additional articles based on previous selections by the user and/or the searching (querying or browsing) of the user (FIG. 7B). By selecting the articles, the user essentially teaches the system their own preferences towards articles and categories. For example, the system may learn that a user prefers articles in the “entertainment” category as opposed to the “politics” category if the user consistently selects several entertainment articles and no or a limited number of politics articles. Similarly, the system may learn that a user prefers topics in certain categories. For example, a user may consistently select golf articles, but not select any basketball articles. The system can then learn that the user is interested in articles about golf. Similarly, the system may learn that a user prefers articles relating to a certain region of the country or world. For example, a user may consistently select articles relating to New Jersey, and the system can, therefore, learn the user prefers articles about New Jersey. If the system recognizes that a user selects, for example, three articles from the “entertainment” category and one article from the “business” category, the system can present the same ratio (3:1 in the example) of articles to the user. In another example, a user may select certain category tabs when browsing news information more frequently than other category tabs. The system can also learn a users preferences toward categories by monitoring the selections of category tabs without necessarily monitoring specific user selections of articles.

The system's learning can be stored locally and/or remotely. For example, the system can store a series of browser's cookies on the user's computers. In another example, data can be stored at a server of a user's service provider. As a result, a centralized database, associated with the search engine, would not be required. Alternatively, the data can be stored in a centralized database associated with the search engine.

This process of learning about the user can be used to personalize a presentation of news articles for each user. In one embodiment, more articles in categories in which the user is interested can be presented or more articles in topics in which the user is interested can be presented.

The system can also automatically select, highlight or suggest news information that may interest the user or updates on articles which the user was previously interested in. For example, when new cluster(s) are added to a chain, the new cluster(s) can be presented to the user.

Thus, the user is able to visually select news information, such as, for example, topics, news clusters or chains, categories, entities (e.g., names, companies, movies, etc.) that interest the user. The selection may be implicit and is a consequence of the normal browsing activities for visualizing the news information. The system can provide the user with a personalized newspaper based on the visual selections. The personalized newspaper may include news information that is, for example, news information related to the selected news information, a personalized mix of categories and/or a personalized set of tracked entities, and the like. For example, a “techie” will build a newspaper with articles about technology and technological gurus such as Linus Torwalds, Steve Jobs, etc. The techie will also probably have stock information on the personalized newspaper. On the other hand, a young girl will build a newspaper by adding gossip articles and celebrities. Thus, the system provides a visual mechanism for selecting news information of interest to the user. In addition, the system also implicitly learns information about the user, which is derived by the normal browsing activity of the user.

The information can also be used to boost the ranking of certain articles. In one embodiment, the information can be used to improve, decrease or modify the ranking of news clusters, news articles, web sites, images, videos sounds and search queries related to the user's selections.

In addition, the user can personalize the presentation of the news information. For example, the user may be able to modify the on-screen layout of the page, modify the printing layout of the page, modify the colors, sizes, fronts, etc. of objects on the newspaper, modify the order of clusters/articles shown, modify the ranking of news sources providing articles, modifying the ranking of blog sources that provide blog postings, and the like. In one embodiment, the user can change the title associated with a cluster or chain of articles. The user may also be able to select a different media element (e.g., image, video, audio content) associated with a cluster and/or chain.

The personalization can be monitored and used by the system to learn about the user. In one embodiment, the system uses the personalization data to improve, decrease, or modify the ranking of news clusters, articles, web sites, images, videos, audio content and search queries related to the data.

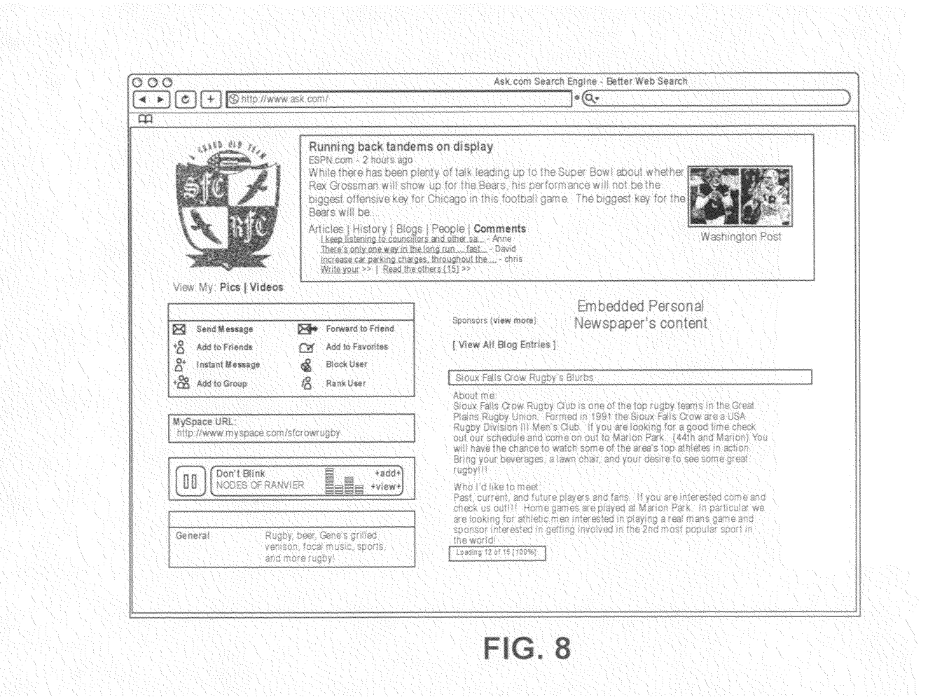

In addition, the user may be able to share their personalized newspaper with other users. The personalized newspaper can be embedded in a web page or blog published on the Internet. A pull technology, such as a XML, RSS or Atom feed, or generation of an HTML snippet, can used by the service provider's servers to provide a link to the personalized newspaper. For example, FIG. 8 shows a link to the personalized newspaper in a user's “myspace” page. In another example, a user can email a link to the personalized web page to other users.

In one embodiment, the personal newspaper of user UA may be univocally represented by a URL (UA) that can be exchanged on the Internet with other users via, for example, instant messaging, email, text messaging, links in web pages, and the like. A second user UB can select user UA's URL (UA) and access the personal newspaper of user UA. In one embodiment, user UB can leave comments on user UA's page. Thus, user's can share their personalized newspapers.

The user may be able to post comments or allow others to post comments on their personalized newspaper. The user can also remove their own comments or other's comments from the newspaper.

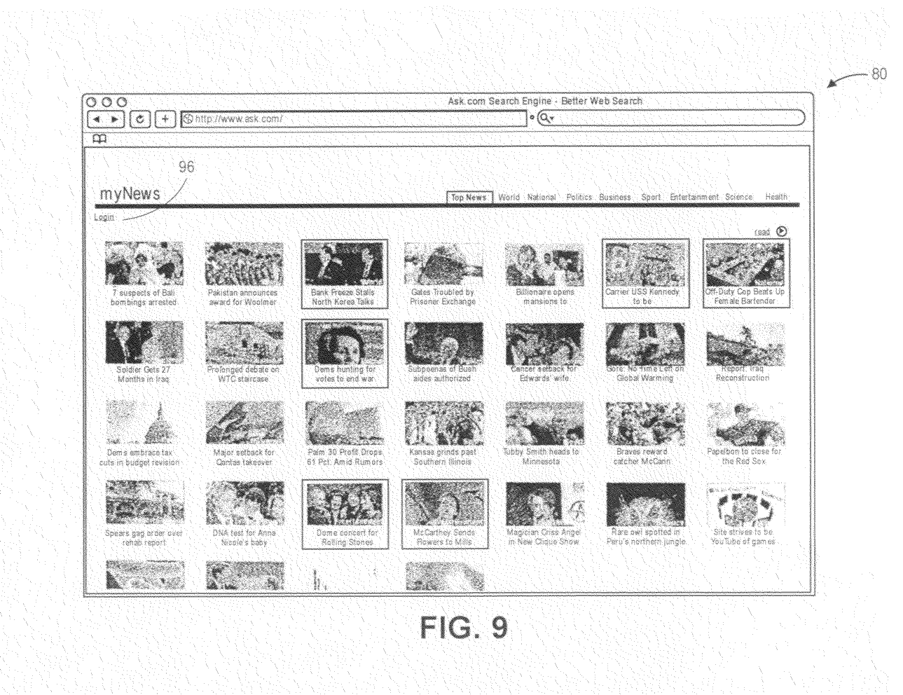

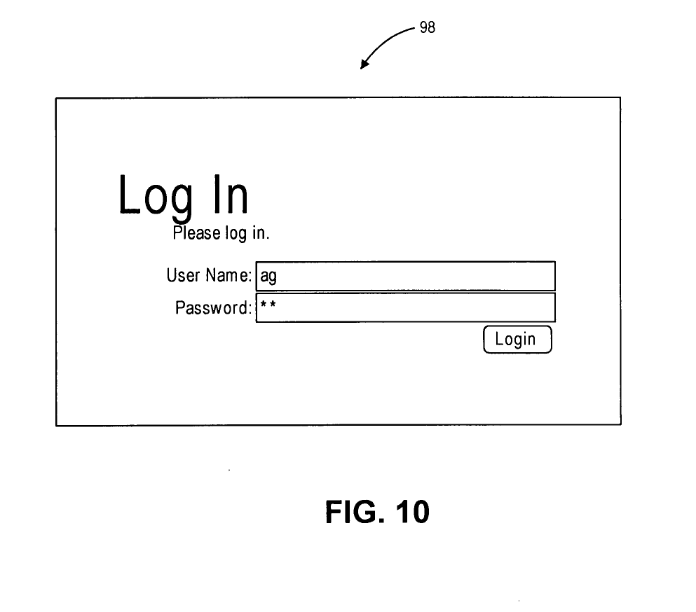

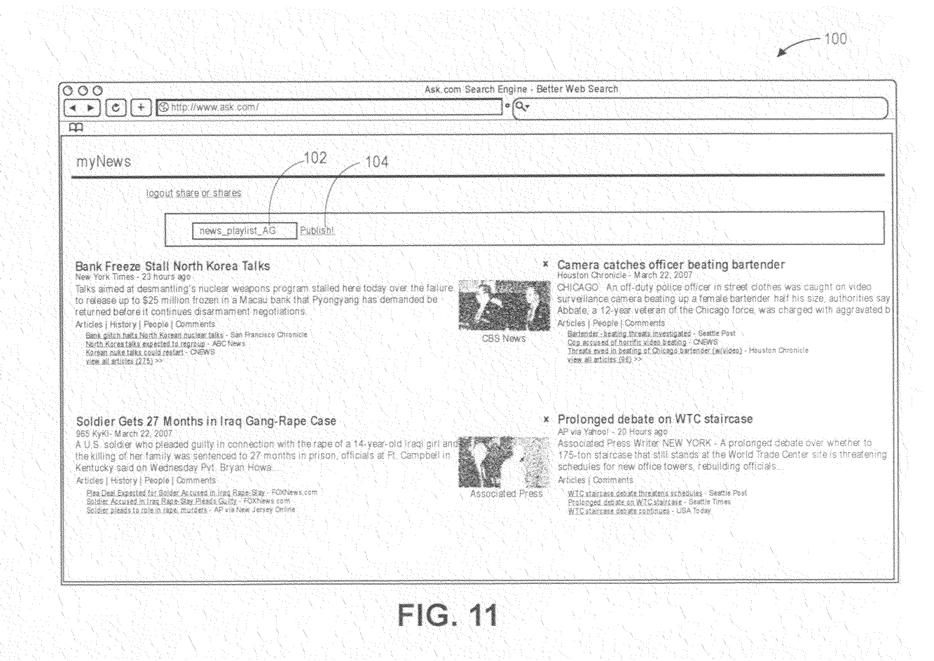

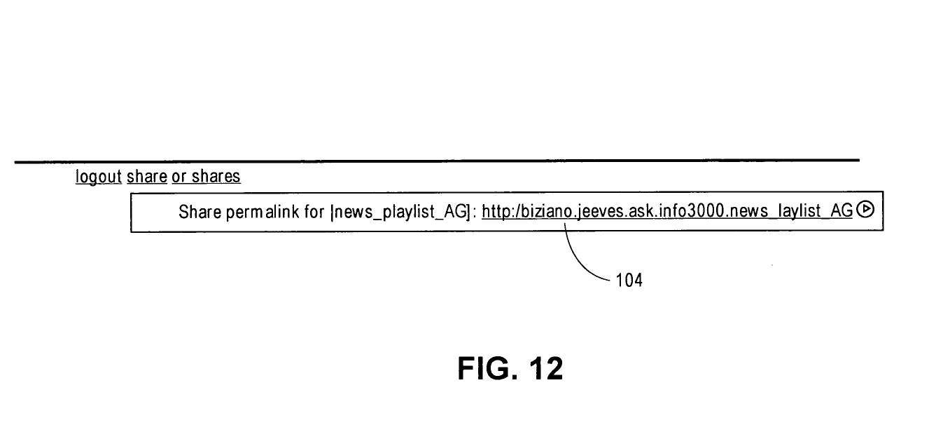

FIG. 9 illustrates a user interface similar to the user interface 80 of FIG. 4. In FIG. 9, the user interface 80 includes a link 96, designated by “login.” The login system provides another technique for presenting and storing personalized news information. The user can select the link 96 in the user interface 80 to access personalizable and personalized news information. In one embodiment, when the user selects link 96, the user is directed to the user interface 98 shown in FIG. 10. In one embodiment, the user enters a user name and password to access their personalized information. It will be appreciated that a user will have to set up the login information, as well known in the art. FIG. 11 shows an exemplary personalized newspaper 100 associated with a user after logging in to the system using the interface 98 of FIG. 10. The illustrated personalized newspaper 100 also includes a box 102. The personalized newspaper 100 is similar to the personalized newspapers discussed above with reference to FIGS. 7A and 7B. A user can enter a name for their personalized newspaper in the box 102. A link 104, designated by “Publish”, is provided next to the box 102 in FIG. 11. When a user selects the link 104, the user creates a link 104, as shown in FIG. 12. The link 104 is a shareable link for the personalized newspaper 100 of FIG. 10. The user can then share the link 104 with other people to allow the other people to access the personalized newspaper.

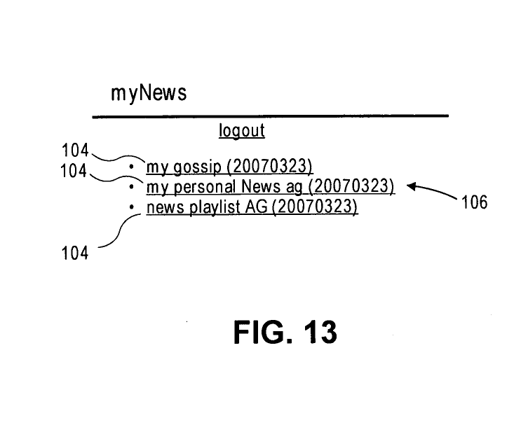

In one embodiment, the user can create multiple personalized newspapers. Each of the multiple personalized newspapers can be shared as well. As shown in FIG. 13, a list 106 of different personalized newspapers can be provided. In the illustrated example, the user has created three different personalized newspapers: “my gossip,” “my personal News ag,” and “news playlist AG.” A user can select any of the links to access their different personalized newspapers. It will be appreciated that the user can choose to share different newspapers with different people. Having different personalized newspapers also allows a user to access different types of news. For example, a user can create a first personalized newspaper with stock information and weather, which the user checks on a daily basis, and a second personalized newspaper with politics information and sports information, which the user checks on a weekly basis.

In addition, the personalized newspapers can be personalized to groups of users. That is, the personalization need not be limited to a single user. For example, a group of fans of Angelina Jolie can create a personalized newspaper with news information related to Angelina Jolie. In another example, a group of financial investors in New York can create a personalized newspaper with financial news information in New York. In yet another example, a Generation Y group from San Francisco can create a personalized newspaper with information about local San Francisco news information or information about new restaurants or social news.

These personalized newspapers for groups of users can also be shared, as discussed above. Thus, all of the people in the Generation Y group from San Francisco group can access their associated personalized newspaper. Or, all of the Angelina Jolie fans can access their associated personalized newspaper with news information about Angelina Jolie.

In embodiments in which groups of users create and share group personalized newspapers, it will be appreciated that certain member(s) of the group may have read and write access/rights. Alternatively, all members may have read and write access/rights.

In addition, the personalized newspaper may be annotated and/or tagged with descriptive labels provided by users in a collaborative effort. For instance, a shared newspaper about gossip can be annotated with labels such as “gossip”, “paparazzi”, “scoop”, “celebrities”, etc, while a shared newspaper about financial news can be annotated with labels such as “finance”, “stocks”, “quarter results”, etc. The annotated/tagged newspaper can then be searched so that users can find newspapers that interest them.

The foregoing description with attached drawings is only illustrative of possible embodiments of the described method and should only be construed as such. Other persons of ordinary skill in the art will realize that many other specific embodiments are possible that fall within the scope and spirit of the present idea. The scope of the invention is indicated by the following claims rather than by the foregoing description. Any and all modifications which come within the meaning and range of equivalency of the following claims are to be considered within their scope.

1. A method for presenting electronic information comprising:
clustering news information according to a topic to create topic clusters, each topic cluster having a news information object associated with the topic cluster;
presenting the news information objects associated with the topic clusters in a user interface; and
receiving a user selection of one or more of the news information objects in the user interface.

2. The method of claim 1, further comprising presenting the user with news information associated with the selected topic clusters.

3. The method of claim 1, further comprising allowing the user to access a personalized newspaper, the personalized newspaper including news information associated with the topic cluster.

4. The method of claim 1, further comprising associating a news information object with a topic cluster.

5. The method of claim 1, wherein the topic cluster is part of a topic chain, and wherein the news information object is associated with the topic chain.

6. The method of claim 1, wherein the news information object consists essentially of a representative image and a representative title.

7. The method of claim 1, wherein the user selection comprises a mouse click.

8. The method of claim 1, further comprising highlighting the news information object in the user interface when a user selection is received.

9. The method of claim 2, wherein presenting comprises presenting the user with an article from a selected topic cluster.

10. The method of claim 3, wherein the personalized newspaper comprises an article from a selected topic cluster.

11. The method of claim 1, further comprising storing user selection of news information objects.

12. The method of claim 11, further comprising presenting the user with unselected news information based on stored user selections.

13. The method of claim 11, further comprising presenting the user with updated news information based on stored user selections.

14. A method for presenting electronic information comprising:
allowing a user to access a collection of visual objects, each visual objected associated with at least one news article;
receiving a user selection of one or more visual object from the collection of visual objects; and
presenting a personalized newspaper including news information relating to the at least one news article associated with each selected visual object.

15. The method of claim 14, wherein each visual object in the collection of visual objects is associated with a representative title, the user selecting either or both of the one or more visual objects or representative titles.

16. The method of claim 14, wherein presenting comprises presenting an abstract of a selected news article and a link to access the entire article.

17. The method of claim 14, further comprising receiving a user modification of a layout of the personalized newspaper.

18. The method of claim 14, further comprising allowing a user to share the personalized newspaper.

19. The method of claim 14, wherein the collection of visual objects is categorized, and wherein the user is allowed to access the visual objects based on a selected category.

20. The method of claim 14, further comprising providing the user with unselected news information related to a selected article.

21. The method of claim 14, wherein the visual objects comprise images.

22. The method of claim 14, wherein the visual objects comprise videos.

23. The method of claim 14, further comprising a plurality of users to access the collection of visual objects.

24. The method of claim 14, further comprising annotating the personalized newspaper with a label, the label related to at least one topic of the personalized newspaper.

25. The method of claim 25, further comprising allowing a user to locate a personalized newspaper related to the at least one topic by searching for the label associated with the at least one topic.
